(19) United States
(12) Patent Application Publication
(10) Pub. No.: US 2016/0090040 A1
(43) Pub. Date: Mar. 31, 2016

(54) Vehicle Monitoring Device

(71) Applicant: Ian Marsh, Brampton (CA)

(72) Inventor: Ian Marsh, Brampton (CA)

(21) Appl. No.: 14/501,341

(22) Filed: Sep. 30, 2014

(51) Int. Cl. B60R 1/00; H04N 7/18

(52) U.S. Cl. CPC B60R 1/00; H04N 7/181

(57) ABSTRACT

A vehicle monitoring device provides comprehensive monitoring of areas both outside and within a vehicle. The device includes a plurality of operational controls positioned within an interior space of a vehicle. A monitor is positioned in the vehicle and operationally coupled to a processor such that the monitor displays images transmitted to the monitor from the processor. Each of a plurality of cameras is communicatively coupled to the processor. The cameras include exterior cameras outwardly directed for exterior images and an interior camera directed towards the interior space of the vehicle communicating an image of the operator of the vehicle to the processor. A transmitter is communicatively coupled to the processor wherein the image of the operator of the vehicle is transmitted to an extrinsic device relative to the vehicle.

### BACKGROUND OF THE DISCLOSURE

### Field of the Disclosure

The disclosure relates to monitoring devices and more particularly pertains to a new monitoring device for comprehensive monitoring of areas both outside and within a vehicle.

### SUMMARY OF THE DISCLOSURE

An embodiment of the disclosure meets the needs presented above by generally comprising a plurality of operational controls positioned within an interior space of a vehicle. A monitor is positioned in the vehicle and operationally coupled to a processor such that the monitor displays images transmitted to the monitor from the processor. Each of a plurality of cameras is communicatively coupled to the processor. The cameras include exterior cameras outwardly directed for exterior images and an interior camera directed towards the interior space of the vehicle communicating an image of the operator of the vehicle to the processor. A transmitter is communicatively coupled to the processor wherein the image of the operator of the vehicle is transmitted to an extrinsic device relative to the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a vehicle monitoring device according to an embodiment of the disclosure.

FIG. 2 is a schematic view of an embodiment of the disclosure.

### DESCRIPTION OF THE PREFERRED EMBODIMENT

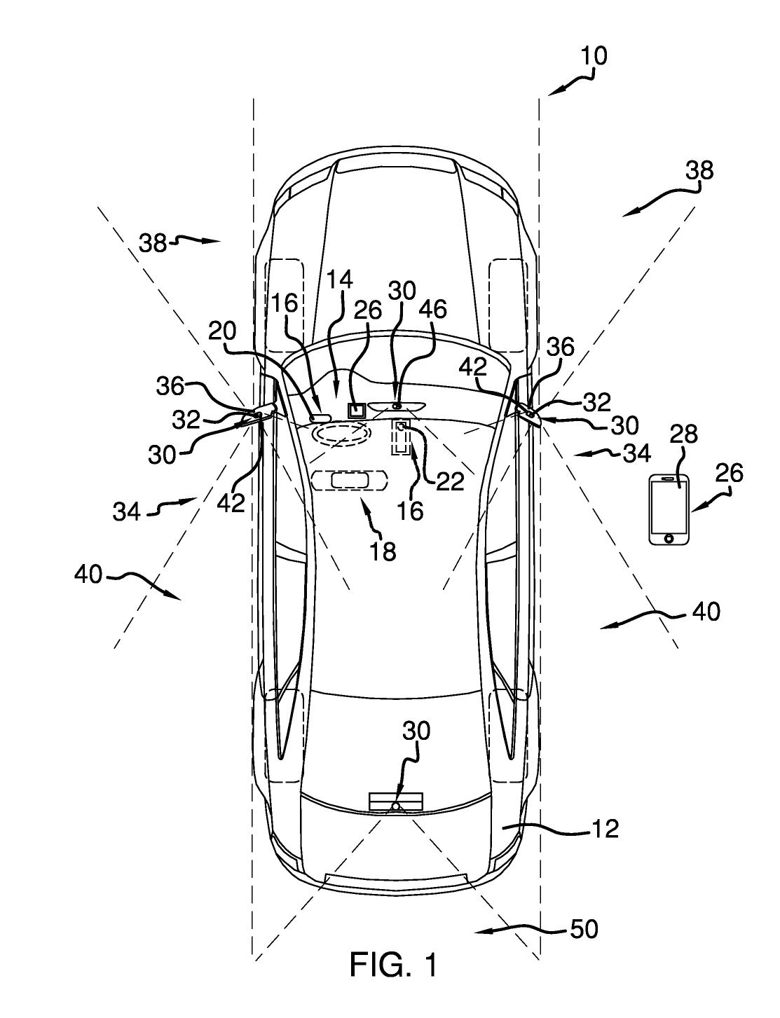

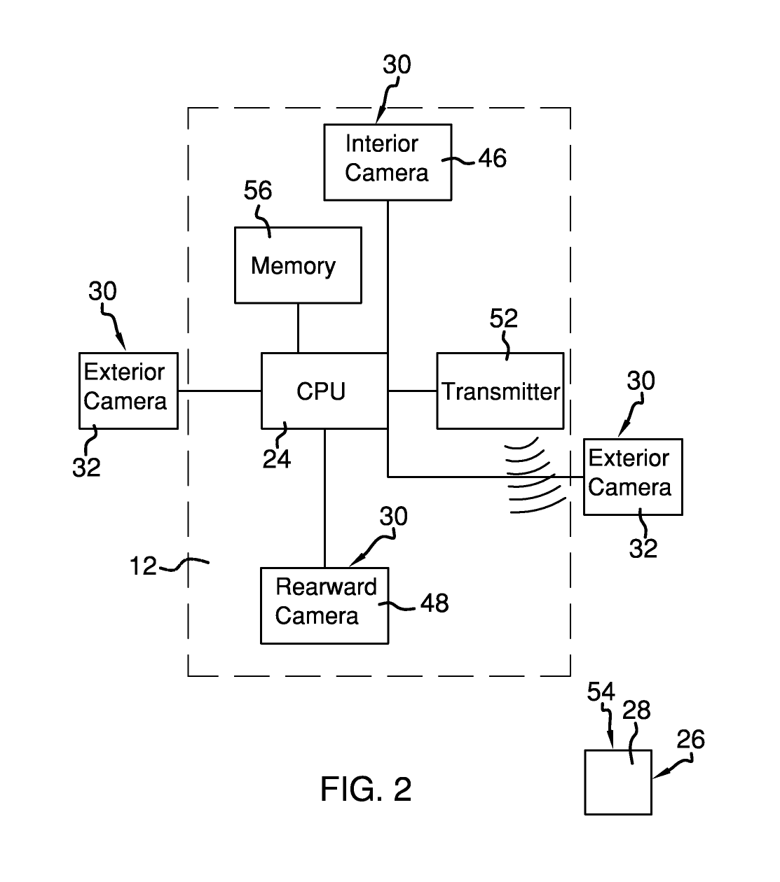

With reference now to the drawings, and in particular to FIGS. 1 through 2 thereof, a new monitoring device embodying the principles and concepts of an embodiment of the disclosure and generally designated by the reference numeral 10 will be described.

As best illustrated in FIGS. 1 through 2, the vehicle monitoring device 10 generally comprises a vehicle 12 having an interior space 14. The vehicle 12 further has a plurality of operational controls 16 positioned within the interior space 14 wherein the vehicle 12 is configured for being controlled by an operator 18 positioned within the interior space 14. The operational controls 16 of the vehicle 12 include a turn signal control 20 and a gear shifter 22 allowing the vehicle 12 to be placed into reverse gear. A processor 24 is coupled to the vehicle 12. A monitor 26 is positioned in the vehicle 12. The monitor 26 may be attached to the vehicle 12 such that the monitor 26 is displayed in a position within the interior space 14 of the vehicle 12 viewable by the operator 18 of the vehicle 12. Alternatively, the monitor 26 may be a portable device 28 such as a smart phone, electronic tablet, or the like, positionable within the interior space 14 of the vehicle 12. The monitor 26 is operationally coupled to the processor 24 wherein the monitor 26 displays images transmitted to the monitor 26 from the processor 24.

Each of a plurality of cameras 30 is coupled to the vehicle 12. Each of the cameras 30 is communicatively coupled to the processor 24 wherein each camera 30 communicates images to the processor 24. The cameras 30 including a pair of exterior cameras 32. Each of the exterior cameras 32 is outwardly directed relative to the vehicle 12 wherein the exterior cameras 32 communicate images from outside of the vehicle 12 to the processor 24. Each of the exterior cameras 32 is positioned on a respective side 34 of the vehicle 12. Each of the exterior cameras 32 is coupled to a respective side view minor 36 of the vehicle 12. Each of the exterior cameras 32 captures panoramic images extending from a forward area 38 relative to the vehicle 12 around a respective the respective sides 34 of the vehicle 12 to a rearward area 40 relative to the vehicle 12. The processor 24 displays images provided to the processor 24 by a respective one of the exterior cameras 32 on the monitor 26 when the turn signal control 18 is actuated. Thus, the monitor 26 provides a visual image on the monitor 26 relating to the intended direction in which the vehicle 12 will be moved. Each of the exterior cameras 32 has an inwardly directed lens 42 wherein each exterior camera 32 further provides images of the interior space 14 of the vehicle 12 captured from outside of the vehicle 12.

The cameras 30 include an interior camera 46 positioned in the interior space 14 of the vehicle 12. The interior camera 46 is directed towards the interior space 14 of the vehicle 12 wherein the interior camera 46 communicates an image of the operator 18 of the vehicle 12 to the processor 24. A transmitter 52 of conventional design is coupled to the vehicle 12. The transmitter 52 is communicatively coupled to the processor 24 wherein the image of the operator 18 of the vehicle 12 is transmitted to an extrinsic device 54 relative to the vehicle 12. Thus, the image of the operator 18 may be accessed and monitored in the event the vehicle 12 is used without proper authorization from an owner of the vehicle 12. A memory unit 56 may be communicatively coupled to the processor 24 either on board the vehicle 12 or in a remote location wherein images communicated to the processor 24 by the cameras 30 are stored on the memory unit 56 for later access. The images stored on the memory unit 56 are retrievable by the extrinsic device 54 relative to the vehicle 12.

The plurality of cameras 30 may further include a rearward camera 48. The rearward camera 48 is directed towards a rear of the vehicle 12 wherein the rearward camera 48 provides images of a rear area 50 directly behind the vehicle 12 to the processor 24. The processor 24 displays the images of the rear area 50 directly behind the vehicle 12 on the monitor 26 when the vehicle 12 is placed into the reverse gear.

In use, the cameras 30 monitor inside and outside the vehicle 12 and display images on the monitor 26 as needed to enhance safe movement of the vehicle 12 and to facilitate retrieval of the vehicle 12 and identification and subsequent prosecution of a thief if the vehicle 12 is stolen.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle monitoring device comprising:
a vehicle, said vehicle having an interior space, said vehicle further having a plurality of operational control positioned within said interior space wherein said vehicle is configured for being controlled by an operator positioned within said interior space;
a processor coupled to said vehicle;
a monitor positioned in said vehicle, said monitor being operationally coupled to said processor wherein said monitor displays images transmitted to said monitor from said processor;
a plurality of cameras coupled to said vehicle, each of said cameras being communicatively coupled to said processor wherein each camera communicates images to said processor, said cameras including a pair of exterior cameras, each of said exterior cameras being outwardly directed wherein said exterior cameras communicate images from outside of said vehicle to said processor, said cameras including an interior camera positioned in said interior space of said vehicle, said interior camera being directed towards said interior space of said vehicle wherein said interior camera communicates an image of the operator of said vehicle to said processor; and
a transmitter coupled to said vehicle, said transmitter being communicatively coupled to said processor wherein said image of the operator of the vehicle is transmitted to an extrinsic device relative to said vehicle.

2. The device of claim 1, further comprising each of said exterior cameras capturing panoramic images extending from a forward area relative to said vehicle around a respective side of said vehicle to a rearward area relative to said vehicle.

3. The device of claim 2, further comprising each of said exterior cameras being positioned on a respective side of said vehicle.

4. The device of claim 3, further comprising each of said exterior cameras being coupled to a respective side view mirror of said vehicle.

5. The device of claim 3, further comprising each of said exterior cameras having an inwardly directed lens wherein each said exterior camera further provides images of said interior space of said vehicle captured from outside of said vehicle.

6. The device of claim 1, further comprising said plurality of cameras including a rearward camera, said rearward camera being directed towards a rear of said vehicle wherein said rearward camera provides images of a rear area directly behind said vehicle to said processor.

7. The device of claim 6, further comprising said processor displaying said images of said rear area directly behind said vehicle on said monitor when said vehicle is placed into a reverse gear.

8. The device of claim 4, further comprising said operational controls of said vehicle including a turn signal control, said processor displaying images provided to said processor by a respective one of said exterior cameras on said monitor when said turn signal control is actuated.

9. The device of claim 1, further comprising said monitor being a portable device positionable within said interior space of said vehicle.

10. The device of claim 1, further comprising said monitor being attached to said vehicle such that said monitor is displayed in a position with said interior space of said vehicle viewable by the operator of the vehicle.

11. The device of claim 1, further comprising a memory unit communicatively coupled to said processor wherein images communicated to said processor by said cameras are stored on said memory unit.

12. The device of claim 11, further comprising said images stored on said memory unit being retrievable by an extrinsic device relative to said vehicle.

13. A vehicle monitoring device comprising:
a vehicle, said vehicle having an interior space, said vehicle further having a plurality of operational control positioned within said interior space wherein said vehicle is configured for being controlled by an operator positioned within said interior space, said operational controls of said vehicle including a turn signal control;
a processor coupled to said vehicle;
a monitor positioned in said vehicle, said monitor being operationally coupled to said processor wherein said monitor displays images transmitted to said monitor from said processor;
a plurality of cameras coupled to said vehicle, each of said cameras being communicatively coupled to said processor wherein each camera communicates images to said processor, said cameras including a pair of exterior cameras, each of said exterior cameras being outwardly directed wherein said exterior cameras communicate images from outside of said vehicle to said processor, each of said exterior cameras being positioned on a respective side of said vehicle, each of said exterior cameras being coupled to a respective side view mirror of said vehicle, each of said exterior cameras capturing panoramic images extending from a forward area relative to said vehicle around a respective side of said vehicle to a rearward area relative to said vehicle, said processor displaying images provided to said processor by a respective one of said exterior cameras on said monitor when said turn signal control is actuated, each of said exterior cameras having an inwardly directed lens wherein each said exterior camera further provides images of said interior space of said vehicle captured from outside of said vehicle, said cameras including an interior camera positioned in said interior space of said vehicle, said interior camera being directed towards said interior space of said vehicle wherein said interior camera communicates an image of the operator of said vehicle to said processor, said plurality of cameras including a rearward camera, said rearward camera being directed towards a rear of said vehicle wherein said rearward camera provides images of a rear area directly behind said vehicle to said processor, said processor displaying said images of said rear area directly behind said vehicle on said monitor when said vehicle is placed into a reverse gear;
a transmitter coupled to said vehicle, said transmitter being communicatively coupled to said processor wherein said image of the operator of the vehicle is transmitted to an extrinsic device relative to said vehicle; and
a memory unit communicatively coupled to said processor wherein images communicated to said processor by said cameras are stored on said memory unit, said images stored on said memory unit being retrievable by an extrinsic device relative to said vehicle.

14. The device of claim 13, further comprising said monitor being attached to said vehicle such that said monitor is displayed in a position with said interior space of said vehicle viewable by the operator of the vehicle.

15. The device of claim 13, further comprising said monitor being a portable device positionable within said interior space of said vehicle.
